(19) United States
(12) Patent Application Publication
(10) Pub. No.: US 2006/0259189 A1
(43) Pub. Date: Nov. 16, 2006

(54) Method and apparatus for printing a gift card

(75) Inventors: David Perlow, Cambridge, MA (US); Jeremy Gilbert, Lowell, MA (US); David Hout, North Andover, MA (US); Gary Snow-Brine, Wells, ME (US)

Correspondence Address: FINCH IP LLC, P.O. BOX 1358, CONCORD, NH, 03302, US

(73) Assignee: Cruz Bay Solutions, Inc.

(21) Appl. No.: 11/432,828

(22) Filed: May 12, 2006

Related U.S. Application Data
(60) Provisional application No. 60/680,216, filed on May 12, 2005.

(51) Int. Cl. G06F 17/00; G06Q 30/00

(52) U.S. Cl. 700/231; 705/14

(57) ABSTRACT

The disclosure pertains to a self-service kiosk for customizing, printing and dispensing an activated gift card on location. The self-service kiosk may include at least one central processing unit, a display, at least one input device, a card printer, and program code for selecting and printing a gift card.

### RELATED APPLICATION

This application claims benefit of U.S. Provisional Patent Application Ser. No. 60/680,216, titled “METHOD AND APPARATUS FOR PRINTING A GIFT CARD” filed May 12, 2005.

### BACKGROUND

1. Field of the Invention

The present invention relates to a self-service kiosk and, in particular, to a self-service kiosk for customizing, printing and dispensing an activated gift card.

2. Discussion of Related Art

In recent years, retailers have implemented various programs to encourage current and future customers to purchase an increasing amount of products and services from their stores. One such program involves the sale of pre-paid gift or debit cards. By offering gift cards to customers, retailers benefit from increased business as well as from a reduced number of returned opened or unopened gifts which can be potentially time-consuming and expensive for the retailer to restock and resell. These cards, in return, offer a customer an easy and convenient gift idea.

Traditionally, these gift cards were offered in fixed monetary values and displayed at or near the cash register. Upon checking out, customers had the opportunity to purchase the gift card along with the other items they had selected for purchase.

This traditional approach, however, has several disadvantages. First, seasons in which gift cards are most popular are also seasons in which retailers see the longest checkout lines. Thus, a customer wishing to purchase a pre-paid gift card would need to stand in potentially long lines to do so. Additionally, if a customer wishes to buy gift cards for use at different retailers, the customer would need to visit each retailer and wait in a number of long lines to purchase each retailer's gift card. Furthermore, the purchaser cannot customize the card to include a special message for the recipient of the card.

To reduce the time a customer spends in line and to conserve financial resources spent on hiring additional staff during busy hours, businesses can now use self-service kiosks. Customers can now purchase pre-paid retailer specific debit cards at a kiosk for use at that particular retailer.

While these kiosks help customers to avoid waiting in long checkout lines, a customer may still be required to travel to each individual retailer to buy that retailer's gift card. Moreover, a purchaser cannot customize the card to include personalized graphics or text. Thus, there is a need for devices that can print and dispense gift cards on site.

### SUMMARY OF INVENTION

The invention pertains to a self-service kiosk for printing and dispensing an activated gift card. The self-service kiosk may include at least one central processing unit, a display, at least one input device, a card printer, and executable computer code stored on computer readable memory, the code for selecting and printing a gift card, all of which are in communication with the central processing unit.

In another aspect the invention pertains to a method for personalizing a gift card by selecting a gift card type, activating a gift card at a gift card kiosk with a pre-assigned or user-assigned denomination value, printing on the gift card at the kiosk, and dispensing the gift card to the user.

In another aspect a gift card printing kiosk is provided, the kiosk comprising computer processing means for executing program code, printing means for printing graphics and/or text to a gift card, output means for communicating with a user, and network means for connecting to a computer network.

The subject matter of this application may involve, in some cases, interrelated products, alternative solutions to a particular problem, and/or a plurality of different uses of a single system or article.

### BRIEF DESCRIPTION OF DRAWINGS

In the drawings:

FIG. 1 provides an overview of a gift card system;

FIG. 2 is a flow chart diagram showing the flow of information between the major system components of one embodiment of the invention;

FIG. 3 is a flow chart diagram showing the general flow of the application environment software as it will appear to the user of the gift card system in one embodiment of the invention;

FIG. 4 provides a schematic illustration of a view of the front surface of a gift card produced using an embodiment of the invention; and

FIG. 5 provides a schematic illustration of a view of the back surface of a gift card produced using an embodiment of the invention.

### DETAILED DESCRIPTION

The following description pertains to a method and apparatus for customizing, printing and dispensing an activated gift card. The apparatus can be any self-service device, such as a kiosk, that incorporates a printer that can print to either side or both sides of the gift card prior to dispensing it to the user. This self-service device can run a software application environment that allows a user to personalize each gift card by selecting, for example, graphics and text to print on the card. The software may also allow the user to provide the information required to purchase and activate each card. This software application environment may include interfaces between the major physical components of the self-service kiosk and may communicate with a remote server for purposes of obtaining transaction authorization. By incorporating a card printer within or attached to the kiosk and printing the gift card at the time of sale, the system can support any number of gift card designs for any number of different retailers. Pre-set designs may be chosen by the user and printed to the card or the user may be able to customize the card as described below.

Customization options allow the user to add personalized graphics such as a photograph, clip art or handwriting to the gift card. Photographs may be uploaded from user devices such as digital cameras and cell phones or the kiosk may include a camera for taking digital images on site. Any number of retailer logos and designs may be associated with a kiosk as cards need not be pre-printed prior to their sale at the kiosk. Furthermore, digital designs can be uploaded quickly from a central location to provide, for example, holiday or seasonal designs. Designs may also be customized for specific geographical areas. For instance, cards sold in specific regions may include graphics for local sports teams, points of interest, or celebrities. In some embodiments, designs may be drawn from onsite databases, offsite databases, from a user device such as a cell phone or from an input device such as a tablet/stylus. The different designs may be used independently or together on a single gift card.

Retailers and/or card issuers may include additional printable information or identifying features such as URL's, advertising directed to the purchaser's demographic, memberships, and virtual coupons. Designs may be stored in a user's “account” so that they can be edited and re-purchased in the future.

A printer may be controlled via an interface with the CPU. The printer may be contained in the kiosk or may be external from the kiosk. Various printers may be used and can be chosen based on, for example, the composition of the card to be printed as well as the type of graphics to be printed. For detailed color printing on plastic gift cards, a re-transfer process may be preferred. For instance, dye sublimation re-transfer printing can provide for detailed color graphics with excellent resolution and durability. Cards may be printed on one or two sides and may be printed multiple times.

As illustrated in FIG. 1, a user may approach gift card printing kiosk 16 to customize and purchase a gift card which may be printed, activated and dispensed from kiosk 16 while the user waits.

In one preferred embodiment, the gift card printing kiosk includes CPU 23, computer readable memory for executing the program code of application environment 14 under the direction of CPU 23, a storage device, and at least two output and/or input devices 18 and 19. CPU 23 may be a PC and may use, for example, Microsoft Windows XP operating system and Cruz Bay Solutions' iGift Application. In order for the user to communicate with kiosk 16, it preferably includes at least one, or a combination of, the following input devices: a touch screen display, a microphone, a keyboard and mouse, and a tablet and stylus along with an appropriate interface which allows the respective input device to communicate with CPU 23. The major physical components of kiosk 16 may be housed within one single cabinet or within multiple cabinets.

Optional input ports and devices may include, for example, a digital media reader, a universal serial bus (USB) port for downloading media from a thumbnail drive or other device, a firewire port, a microphone for voice activated control, a DVD or CD or other optical drive, a scanner for scanning images, a camera, a BLUETOOTH interface device and/or an infrared port for uploading media via infrared transmission. The kiosk 16 may also contain input devices including identification devices such as magnetic stripe card reader/writer, a UPC scanner, or a RFID reader. Each input device may also have the appropriate interface to enable the input device to communicate directly with the CPU. The kiosk may also include a secure PIN entry device. The PIN entry device may allow entry of a personal identification number that may be required to activate a payment source such as a debit card. User identification and authentication can also be verified by using a biometric identifier such as, for example, a fingerprint or iris scanner. Voice authentication may also be used. In some embodiments, one or more input devices may also serve as output devices. For example, a user may be able to save a card design to a digital media card or other device.

Output devices linked to CPU 23 of kiosk 16 may include a monitor and/or a card printer 24 and/or a receipt printer. The monitor may be used to query the user and may provide an image of the gift card prior to printing. Gift card printers include, for example, inkjet, laser and dye sublimation printers. Printers may be chosen, in part, based upon the material that the gift card is composed of. Gift cards to be printed may be made of synthetic or natural materials. Synthetic materials include, for example, PVC, PET, PET-G, ABS and/or polycarbonate. Natural materials include, for example, paper and/or materials made from corn such as CornCard USA cards (Arthur Blank & Co., Boston, Mass.) made from NatureWorks PLA plastic substitute.

A preferred embodiment uses dye sublimation re-transfer technology, as in Dai Nippon Printing's DNP CX series printers. It has been found that dye sublimation re-transfer printing is a preferred technology. This technique has been shown to provide superior looking graphics on gift cards when compared to other tested printing methods. A dye sublimation re-transfer printer may be capable of printing to either or both sides of a gift card.

By printing a gift card at the time of sale, the system can support any number of gift card designs for any number of different retailers. This may also allow retailers and other gift card vendors to instantly update designs. For example, seasonal designs may be implemented at appropriate times or weddings, birthdays or sports championships may be instantly memorialized on a gift card. Other output devices may include receipt printer 12 such as the Star TUP 992, a display, and speakers.

Network appliance 13 may also be included with kiosk 16 and may communicate either wirelessly or via wires with a network such as a LAN or the internet. Network appliances such as the Multitech MTCBA-G-UF2, which is a wireless GPRS modem may allow remote management, access to the world-wide web and/or communication with external servers such as transaction server 26 or a server for gift card activation or payment. Other wireless protocols include, for example, CDMA, SMS and iDen. Communication may be incoming, outgoing, or both.

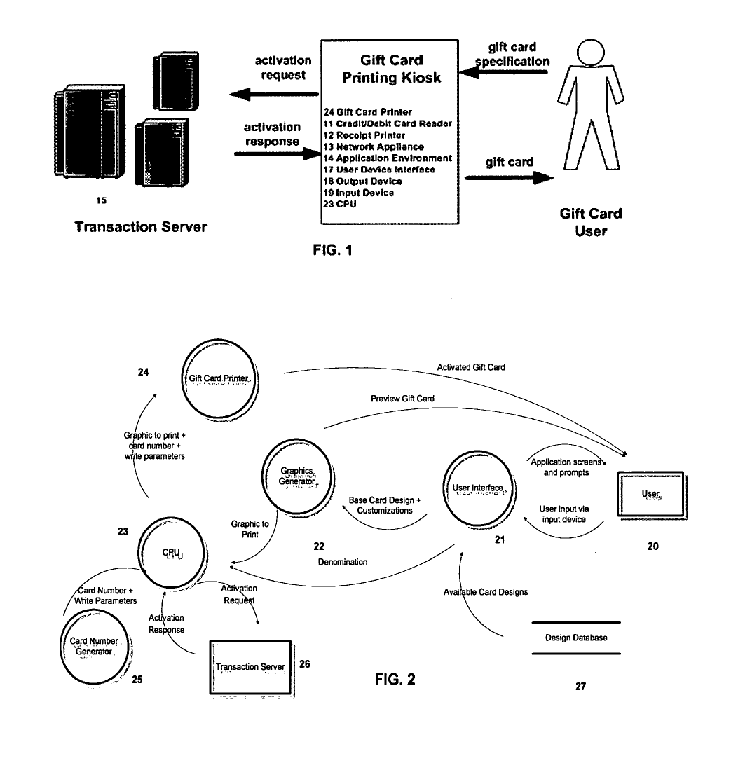

As illustrated in FIG. 2 and FIG. 3, a user may approach kiosk 16 to produce a gift card. User interface 21 can provide the user 20 with various screens and graphical or voice prompts which can help guide the user 20 through the process. After the user has approached and engaged kiosk 16, the user may be presented with selection menu 30 through user interface 21 from which he or she may pick a gift card template from a list of available gift card templates. These templates may be stored as digital graphic files in design database 27. Design database 27 may be local to the kiosk 16 or may be distributed over a wired or wireless network such as a LAN or the Internet. Furthermore, the design database 27, if distributed over a network, can serve multiple kiosks and a single kiosk may support the production of gift cards from multiple gift card sellers. Furthermore, the user may be able to choose to print 1, 2, 3 or more cards of a single or different design and/or denomination.

Once the user has selected a gift card template, user interface 21 may prompt the user to print, customize or personalize the gift card. The prompt may be aural or visual and the user may communicate with the device using, for example, a keyboard, tablet, touch screen, or voice recognition software. Voice recognition software may be capable of translating voice to text and may optionally be used in conjunction with a synthetic voice generator to promote a two-way voice conversation between the kiosk and the user.

If personalization of the gift card is desired, personalization editor 31 can be displayed, for example, on a computer monitor. The personalization editor may be a WYSIWYG “what you see is what you get” type, where a user can preview the appearance of graphics and text as it will appear on the final printed gift card. The image, or portions of the image, may be enlarged to promote, for example, ease of editing. The user will have the option of downloading digital graphics from a personal device connectable through user device interface 17. Personal devices may include, for example, a camera, a flash drive, a mobile telephone, a web-enabled device, an MP3 player, optical media such as a CD or DVD or any other device capable of retaining digital information or images. User device interface 17 may be wired or wireless and may include the following: USB, infrared, firewire, BLUETOOTH, an optical reader, or other suitable interface. The user may also pull digital graphics from design database 27. Text may also be created for the card by means of a physical keyboard or a virtual keyboard displayed on a touch screen. Graphics generator 22 may be used for dynamically creating new graphics and formatting existing graphics for overlay upon the selected base gift card template. Once graphics and text are created and/or selected, user interface 21 may prompt the user for confirmation of the final design 32. At this point the card may be printed and remotely activated. After viewing the actual card, the user may be given the option of activating the card if it meets with his or her approval. Alternatively, a card may be activated prior to printing or prior to dispensing.

During the selection and/or personalization process, the user may customize graphics and/or text using editing software such as, for example, the iGift Card™ Personalization Editor (Cruz Bay Solutions, Cambridge, Mass.) which can provide multiple WYSIWYG editing options for text and/or graphics that have been provided either by the user or another source. Text editing options may include, for instance, altering size, location, color and font. In addition, a variety of graphics editing options may be supported such as resizing, panning, flipping, rotating, and applying processes such as sepia, contrast, brighten, darken and conversion to black and white. In some cases, editing functions may be limited or disabled for some graphics. For example, retailer logos that appear on the card may not be editable.

In another embodiment, the card may be printed on location absent any customization by the user. For example, a retailer's logo may be printed on a blank card without any design or text provided by the user. This can allow a single kiosk to be stocked with blank cards that can be printed for any number of different retailers. Retailer logos and other graphics may be uploaded remotely and can be added, removed or changed on short notice. Thus an unlimited number of retailers can be represented at a single kiosk and can also help prevent overruns of pre-printed cards, as may happen, for example, during a holiday shopping season promotion.

In another preferred embodiment, card number generator 25 may obtain an unused number from a card number database which can be local to kiosk 16 or distributed over a network. Once card number generator 25 obtains an unused number from this database it may communicate this number to CPU 23 which may associate the number with a specific card. The number may be associated with the card in one or mulitple ways such as by printing text, printing a bar code, writing to a magnetic strip, or encoding an RFID smartcard or similar. If the number is to be printed, it may be printed, for example, as text, a barcode, or both, at a pre-determined location on the card. Magnetic stripe reader/writer can be used to write the number to the magnetic stripe on the card. Redundant versions of writing the number to the card may be used.

User interface 21 may also prompt the user for the desired value to associate with the gift card. The user may be prompted by user interface 21 to deposit sufficient cash into the note accepter or to swipe or deposit a debit or credit card in the debit/credit card reader so that the account associated with the debit or credit card may be charged an appropriate amount. A transaction server, which may be offsite, can communicate with other parties such as credit card and stored value processors to coordinate the transaction. When sufficient cash has been deposited in the note accepter or when a payment processor verifies that sufficient finds are available in the associated credit/debit account the transaction server may communicate with a stored value processor to request approval of card activation for the desired value. Once the transaction is approved, CPU 23 may provide card printer 24 the print parameters and instructions to print the gift card. CPU 23 may also give write parameters to the magnetic stripe reader/writer along with instructions to write the ID or the value of the card to the magnetic stripe. Once printing to the card and writing to the magnetic stripe is completed the customized gift card can be dispensed to the user. A receipt may also be printed from receipt printer 12 for the records of the user.

In another embodiment, kiosk 16 may also serve as a balance inquiry and recharging station in which a user may insert a gift card to receive a visual and/or a written summary of the value left on the card. The card may or may not have been previously customized. This written summary may be printed on a receipt by receipt printer 12 or printed on the back of the card by the card printer 24 along with, for example, the current date. If the user wishes to place more value on the gift card, he or she may do so in a substantially similar manner as set forth above.

In yet another embodiment, kiosk 16 may dispense gift cards which are pre-activated and thus may not require an activation step. A portion of the card may be pre-printed or may be entirely printed on site. Pre-activated cards may also have pre-set denominations.

Kiosks may also be configured to dispense pre-printed cards in addition to cards printed on site. For example, a kiosk in a shopping mall may issue pre-printed mall gift cards that can be used throughout the mall, but the kiosk may also use on site printing to produce cards for individual retail tenants of the mall.

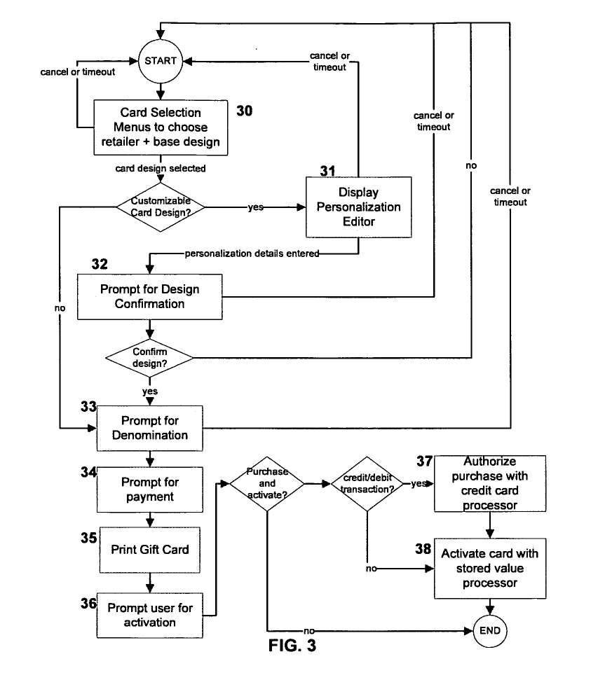

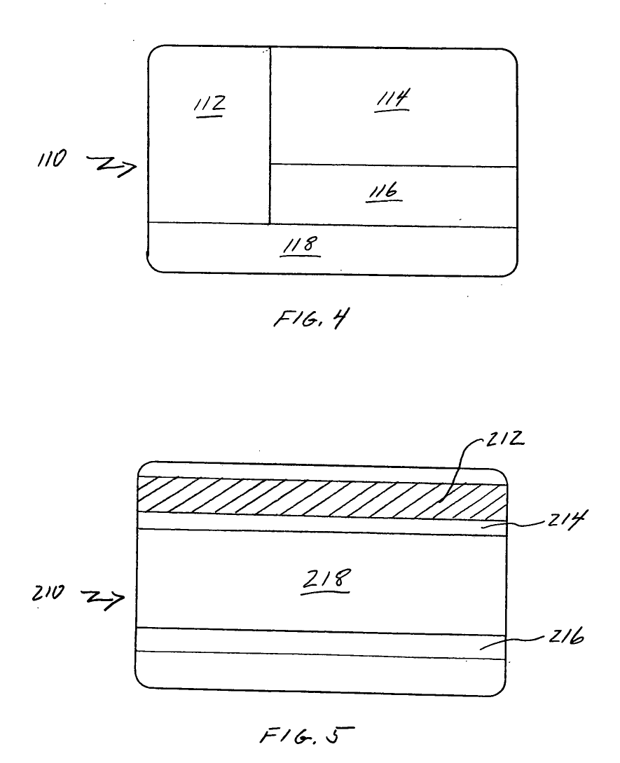

FIGS. 4 and 5 provide, respectively, schematic examples of the front and back surfaces of a gift card printed on site. Front surface 110 may be divided into multiple areas that can be edited independently. Each area may contain different text or graphics and areas may overlap one another in some cases. The number and shape of these sections is unlimited and in some cases may be chosen by the user. In one embodiment, section 112 may include a color photo that has been provided by the retailer and resides on the kiosk or an associated network. Section 114 may be a user-provided photo that has been uploaded from a personal device and edited at the kiosk. Section 116 may contain a personal text message that has been provided by the user. Section 118 may contain one or more logos of a retailer that is associated with the card.

FIG. 5 shows back surface 210 that may include magnetic stripe 212 as well as bar code section 216. In addition, the card number may be printed as text to card number section 214. Thus, the card number may be present in one, two, three or more formats. Section 218 may be used for retailer information as well as terms and conditions. Any or all portions of the card may be printed at the kiosk although portions may also be pre-printed.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined.

All references, patents and patent applications and publications that are cited or referred to in this application are incorporated in their entirety herein by reference.

What is claimed is:

1. A gift card printing kiosk comprising:
a central processing unit for executing program code;
a display and at least one input device;
a card printer; and
executable computer code stored on computer readable memory, the code for selecting and printing a gift card, wherein said card printer, said display and said input device are in communication with said central processing unit.

2. The gift card printing kiosk of claim 1 comprising a storage device for storing graphical images.

3. The gift card printing kiosk of claim 1, wherein said input device is selected from the group consisting of a microphone, a touch screen, a keyboard, and a tablet/stylus.

4. The gift card printing kiosk of claim 1, wherein said card printer comprises a dye sublimation re-transfer printer.

5. The gift card printing kiosk of claim 1 wherein said central processing unit can access a database containing gift card designs and/or digital graphic files.

6. The gift card printing kiosk of claim 1 comprising voice recognition capability for receiving instructions from a user and/or for inputting custom text.

7. The gift card printing kiosk of claim 1, wherein said kiosk further comprises an interface for accessing digital content from a user device.

8. The gift card printing kiosk of claim 1, wherein said kiosk further comprises a scanner and/or a camera.

9. The gift card printing kiosk of claim 1 wherein said kiosk further comprises a network appliance for providing communication between said central processing unit and a remote server.

10. A method of personalizing a gift card comprising:
selecting a gift card type at a gift card kiosk;
activating the gift card at a gift card kiosk with a pre-assigned or user-assigned denomination value;
printing on the gift card at the kiosk; and
dispensing the gift card.

11. The method of claim 10 comprising printing a reverse image onto laminate transfer film and subsequently bonding the laminate transfer film to the face of the gift card.

12. The method of claim 10 comprising printing a photograph on the gift card.

13. The method of claim 10 wherein the card is personalized by means of a WYSIWYG (what you see is what you get) editor such that the user can preview the card design on-screen prior to printing the card.

14. The method of claim 10 wherein the card is printed with a retailer logo.

15. The method of claim 10 wherein the card is printed with a current value and date.

16. The method of claim 10 comprising printing on both sides of the card.

17. The method of claim 10 comprising printing user-provided graphics to the gift card.

18. The method of claim 10 comprising printing on a gift card comprised of paper, PVC, PET, PET-G, ABS, polycarbonate and/or corn-based plastic substitute.

19. A gift card printing kiosk comprising:
computer processing means for executing program code;
printing means for printing graphics and/or text to a gift card;
output means for communicating with a user; and
network means for connecting to a computer network.

20. The gift card printing kiosk of claim 19 comprising data storage means for storing card designs for use in customizing a gift card and/or input means for customizing the gift card.
